(19) United States
(12) Patent Application Publication
(10) Pub. No.: US 2025/0067081 A1
(43) Pub. Date: Feb. 27, 2025

(54) OUTDOOR TENT

(71) Applicant: ZHEJIANG LINYA CO.,LTD., Zhejiang (CN)

(72) Inventors: Niangao ZHAO, Zhejiang (CN); Minjian JIANG, Zhejiang (CN); Rujie FENG, Zhejiang (CN); Zhiping Wang, Zhejiang (CN); Qiang HUANG, Zhejiang (CN)

(73) Assignee: ZHEJIANG LINYA CO.,LTD., Zhejiang (CN)

(21) Appl. No.: 18/806,728

(22) Filed: Aug. 16, 2024

(30) Foreign Application Priority Data
Aug. 23, 2023 (CN) 202322264875.X
Jun. 5, 2024 (CN) 202421269802.8
Aug. 2, 2024 (CN) 202421861381.8

(51) Int. Cl. E04H 15/32; E06B 9/24

(52) U.S. Cl. CPC E04H 15/32; E06B 9/24

(57) ABSTRACT

An outdoor tent includes a tent body and window body components disposed on the tent body; each window body component includes a frame fixed on the tent body, a window frame fixedly embedded on the frame, and a flexible window body disposed in the window frame. An upper part of the flexible window body is fixedly connected to the window frame, and other edges of the flexible window body are connected to the window frame. The flexible window body and the window frame have two layers respectively, and the flexible window body includes an inner light-transmitting window body and an outer screen window. Upper edges of the screen window and the light-transmitting window body are fixedly connected to the window frame, other edges of the screen window are connected to an outer window frame, and other edges of the light-transmitting window body are connected to an inner window frame.

### CROSS-REFERENCE TO RELATED APPLICATION

This application claims the priority benefit of China application serial no. 202322264875.X, filed on Aug. 23, 2023, China application serial no. 202421861381.8, filed on Aug. 2, 2024, and China application serial no. 202421269802.8, filed on Jun. 5, 2024. The entirety of each of the above-mentioned patent applications is hereby incorporated by reference herein and made a part of this specification.

### BACKGROUND

### Technical Field

The present invention relates to the technical field of outdoor goods, in particular to an outdoor tent.

### Description of Related Art

Outdoor tents offer protection against sunlight, UV radiation, wind, and rain, making them widely used in various outdoor settings. Some existing tents have windows that are mostly used for light transmittance or ventilation. However, the windows for ventilation cannot be closed when it rains, and their direct closure would affect ventilation.

For example, the publication No. CN212642300U discloses a tent, wherein wall panels are disposed on a tent frame, and window frames are disposed on door posts. With limited functionality, windows cannot allow ventilation when being closed and cannot keep out mosquitoes when being opened for ventilation.

Additionally, side door and window structures of a plurality of units are disposed on the sides of the outdoor tent, in addition to an openable and closable door. A plurality of openable and closable window body components are disposed on the side door and window structures, but the relative positions of the window body components are fixed, so that people's ventilation and sunshade requirements at different heights cannot be met.

Therefore, there is an urgent need for a side door and window structure for an outdoor awning, which can allow the window body components to be opened at different heights, thus meeting people's ventilation and sunshade requirements at different heights.

Additionally, for existing outdoor tents, tent beams and tent posts are typically molded by aluminum profiles, which results in relatively high overall manufacturing costs. Furthermore, the different assembly structures for the tent beams and the tent posts of various specifications require the profiles of different specifications. For this, its overall manufacturing cost is relatively high.

### SUMMARY

The present invention aims to provide an outdoor tent.

An outdoor tent, including a tent body and window body components, where the window body components are disposed on the tent body; each of the window body components includes a frame, a window frame, and a flexible window body, the frame is fixed on the tent body, an outer edge of the window frame is fixedly embedded on an inner side of the frame, and the flexible window body having at least two layers is disposed in the window frame; an upper part of the flexible window body is fixedly connected to the window frame, and other edges of the flexible window body are connected to the window frame in an openable and closable manner; the flexible window body and the window frame preferably have two layers respectively, and the flexible window body includes an inner light-transmitting window body and an outer screen window; and upper edges of the screen window and the light-transmitting window body are fixedly connected to the window frame, other edges of the screen window are connected to an outer window frame in an openable and closable manner, and other edges of the light-transmitting window body are connected to an inner window frame in an openable and closable manner.

Left, right, and lower edges of the screen window and the light-transmitting window body are connected to an inner edge of the window frame through a zipper or in a magnetic attraction manner.

The light-transmitting window body includes a connecting frame and light-transmitting modules, the light-transmitting modules are fixed on the connecting frame, and an outer edge of the connecting frame is connected to the window frame.

The light-transmitting modules are light-transmitting flexible films which are fixed on the connecting frame through sutures.

The light-transmitting modules are light-transmitting panels that are fixed on the connecting frame through sutures, hooks or magnets are disposed inside lower parts of the light-transmitting panels, and the light-transmitting panels are connected to a ceiling of the tent body through hooks or in a magnetic attraction manner.

Ties are disposed on the tent body, the ties are located above the flexible window body, magic tapes are disposed at upper and lower ends of the ties, the magic tapes are disposed on the tent body, and the magic tapes of the ties are connected to the magic tapes on the tent body in an attaching manner after the flexible window body is rolled up.

Mounting holes are formed in the frame, and the frame is fixed on the tent body through the mounting holes and screws.

A sliding door or a door frame panel is further disposed on the tent body, and the sliding door or/and the door frame panel includes a frame body and a plurality of window body components disposed in the frame body; the frame body is internally provided with at least two parallel sliding chutes, and the sliding chutes are configured to fit in with the window body components; each of the window body components of the sliding door or/and the door frame panel includes a window frame and a window body fixed on the window frame, the sliding chutes are internally provided with insertion holes, and the window frame is correspondingly provided with movable bolts; when the movable bolts are locked with the insertion holes, the window body components of the sliding door or/and the door frame panel are fixed on the frame body; and when the movable bolts are separated from the insertion holes, the window body components of the sliding door or/and the door frame panel are capable of sliding in the corresponding sliding chutes.

Elastic straps are provided between the sliding chutes and the frame body, and the elastic straps deformed are embedded after the movable bolts are adaptively connected to the insertion holes.

Each of the movable bolts includes a pressure spring and a bolt body, a pressure spring seat is disposed at a head part of the bolt body, and an operating handle is disposed at a tail part of the bolt body; and the pressure spring is sleeved on the bolt body, and both ends of the pressure spring are respectively pressed into the pressure spring seat and the window frame.

The window frame includes four corner connectors and four frames, each of the frames is formed by cutting a profile and includes a rectangular chamber and a zigzag-shaped chamber, each of the corner connectors is provided with connecting posts that are perpendicular to each other, and the connecting posts are adaptively inserted into the rectangular chambers.

The window body is provided with a stiffener, both ends of the stiffener are provided with first folding edges, and the first folding edges are located in the zigzag-shaped chambers.

A reinforcing plate is further disposed in the frame body, and a crossbar is disposed between the reinforcing plate and the window frame.

A first fixed support is disposed inside each of left and right sides of the frame body, and second folding edges are disposed on each of left and right sides of the reinforcing plate, and the second folding edges are respectively mounted on the first fixed support through fasteners; a second fixed support is mounted at a lower end of the frame body, and anti-falling plates are mounted on the crossbar and the second fixed support; and the reinforcing plate is provided with a plurality of reinforcing ribs.

To sum up, the tent body includes post corners, ring beams, or middle partition posts, any one of the post corners, the ring beams, or the middle partition posts is formed by adopting a beam-post profile body, the beam-post profile body is internally provided with a cavity part, and the beam-post profile body is molded in a surrounding manner by adopting an iron sheet panel; and one side of the iron sheet panel is a butt-joint edge, and the other side of the iron sheet panel is a fixed edge, and the butt-joint edge and the fixed edge are fixed in a mutual closing and attachment manner.

The butt-joint edge includes a first embedded edge, a first bending part, and a first extension part; the fixed edge includes a second embedded edge, a second bending part, a second extension part, and a connection part, the first extension part is a part of the beam-post profile body, and the first embedded edge, the second embedded edge, the first extension part, and the second extension part are overlapped with one another.

After the beam-post profile body is molded in a surrounding manner, a stamped fastening edge, a first side plate, a first outer side plate, a second outer side plate, and a second side plate are formed, reinforcing grooves are formed in the first outer side plate and the second outer side plate, and the butt-joint edge and the fixed edge are fixed in an overlapping and closing manner.

A cross section of the beam-post profile body is rectangular after being molded in a surrounding manner, and a reinforcing groove is formed in at least one side.

The beam-post profile body includes a profile body and an extension part, and the butt-joint edge and the fixed edge are located on the extension part; the butt-joint edge includes a covered edge, a third bending part, and a third extension part; and the fixed edge includes a third embedded edge and a fourth extension part, and the third embedded edge is located between the covered edge and the third extension part.

A thickness of the beam-post profile body is 0.4 mm to 1.0 mm.

### BRIEF DESCRIPTION OF THE DRAWINGS

FIG. 1 is a structural schematic diagram 1 of an outdoor tent according to the present invention;

FIG. 2 is a left structural schematic diagram of the present invention;

FIG. 3 is a rear structural schematic diagram of the present invention;

FIG. 4 is a structural schematic diagram of a window body component according to the present invention;

FIG. 5 is a structural schematic diagram of a window body component when a screen window is rolled up according to the present invention;

FIG. 6 is a section view of an outdoor tent when two layers of flexible window body are rolled down according to the present invention;

FIG. 7 is a section view of an outdoor tent when a flexible window body having two layers is rolled up according to the present invention;

FIG. 8 is a section view of an outdoor tent when a light-transmitting window body is opened according to the present invention;

FIG. 9 is a section view of an outdoor tent when a light-transmitting window body is opened according to the present invention;

FIG. 10 is a structural schematic diagram 2 of an outdoor tent according to the present invention;

FIG. 11 is a structural schematic diagram 3 of an outdoor tent according to the present invention;

FIG. 12 is a structural schematic diagram of a sliding door or a door frame panel according to the present invention;

FIG. 13 is a sectional structural schematic diagram 1 of a sliding door or a door frame panel according to the present invention;

FIG. 14 is a sectional structural schematic diagram 2 of a sliding door or a door frame panel according to the present invention;

FIG. 15 is a sectional structural schematic diagram 3 of a sliding door or a door frame panel according to the present invention;

FIG. 16 is a partial enlarged structural schematic diagram at a central part I in FIG. 13;

FIG. 17 is a partial enlarged structural schematic diagram at a central part II in FIG. 14;

FIG. 18 is a partial enlarged structural schematic diagram at a central part III in FIG. 14;

FIG. 19 is a partial enlarged structural schematic diagram at a central part IV in FIG. 14;

FIG. 20 is a partial enlarged structural schematic diagram at a central part V in FIG. 14;

FIG. 21 is a partial enlarged structural schematic diagram at a central part VI in FIG. 15;

FIG. 22 is a structural schematic diagram of a corner connector according to the present invention;

FIG. 23 is a structural schematic diagram of an entire profile according to the present invention;

FIG. 24 is a structural schematic diagram 1 of a profile end plane according to the present invention;

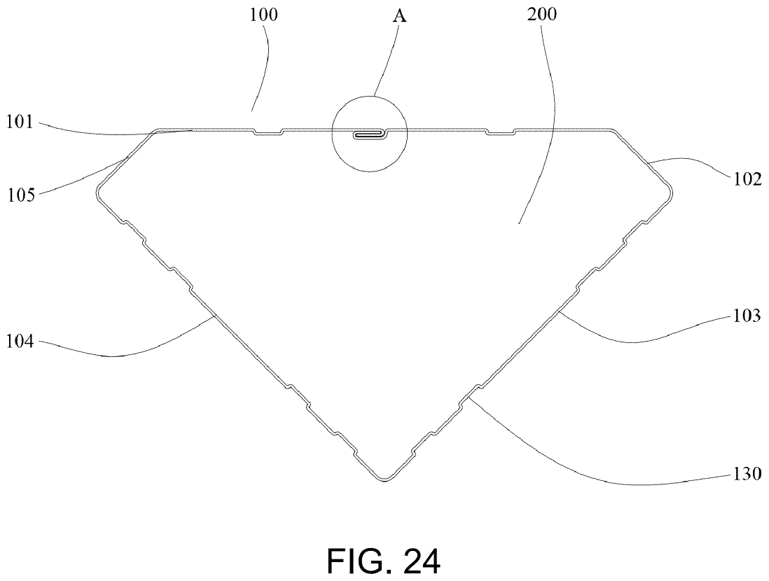

FIG. 25 is a partially enlarged structural schematic diagram at Part A in FIG. 24;

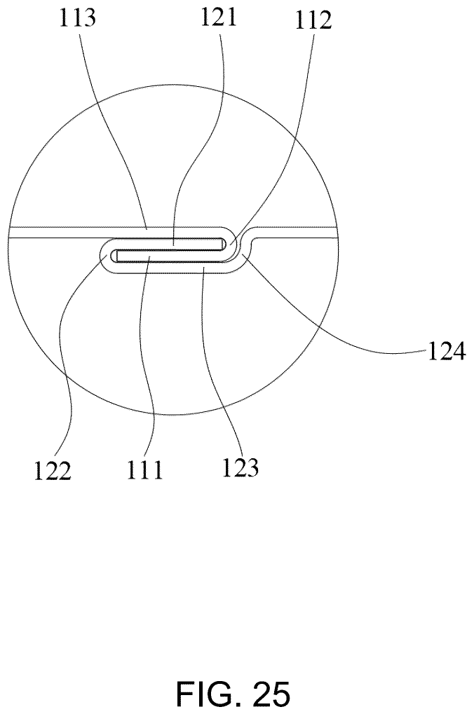

FIG. 26 is a structural schematic diagram of a butt-joint edge according to the present invention.

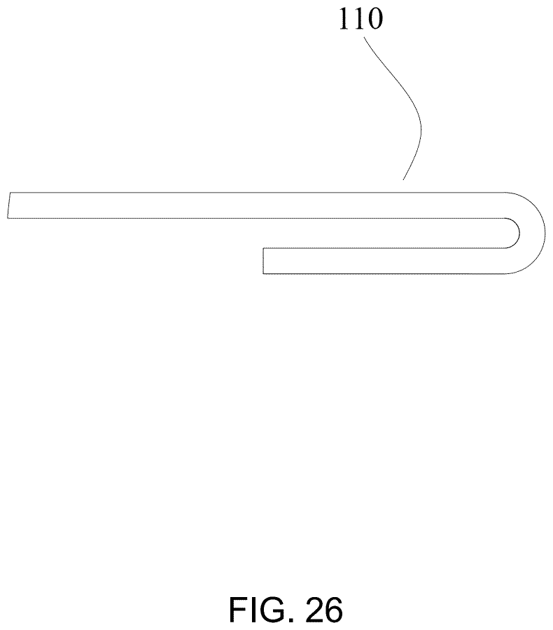

FIG. 27 is a structural schematic diagram of a fixed edge according to the present invention.

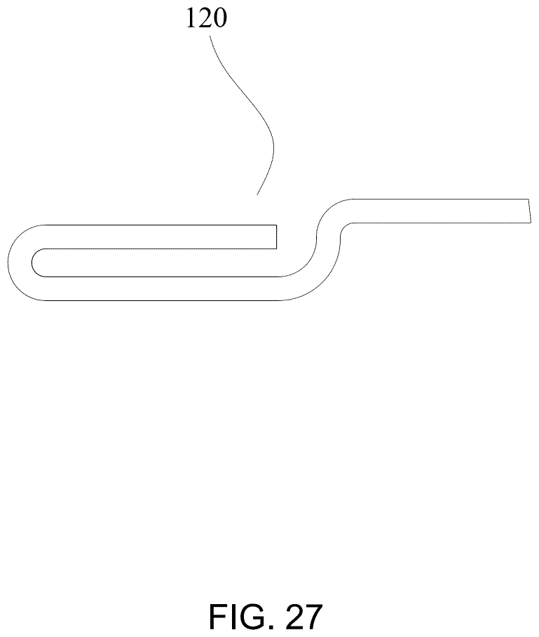

FIG. 28 is a structural schematic diagram 2 of an entire profile according to the present invention;

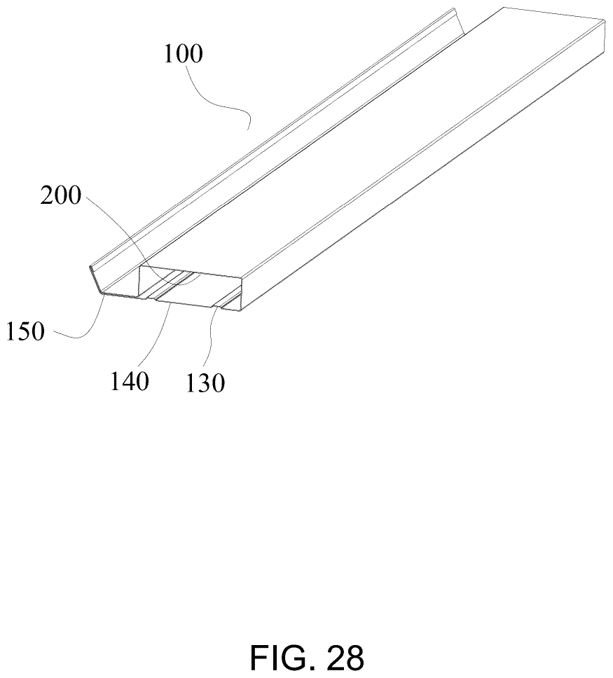

FIG. 29 is a structural schematic diagram 2 of a profile end plane according to the present invention;

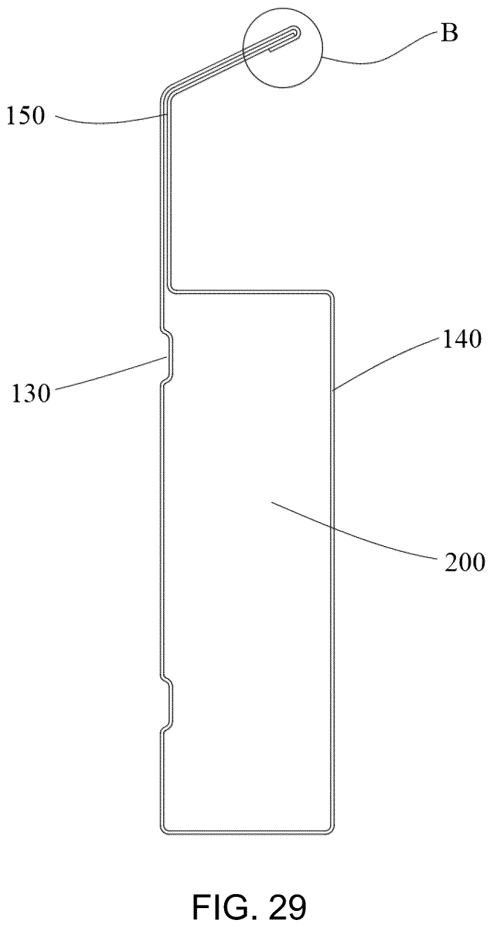

FIG. 30 is a partially enlarged structural schematic diagram at Part B in FIG. 7;

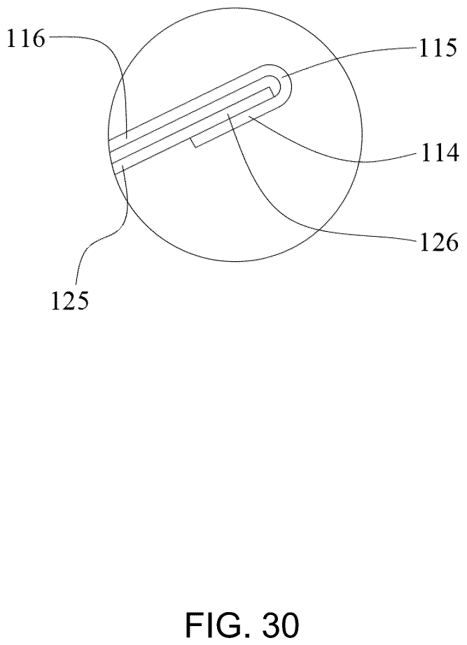

FIG. 31 is a structural schematic diagram 3 of a profile end plane according to the present invention;

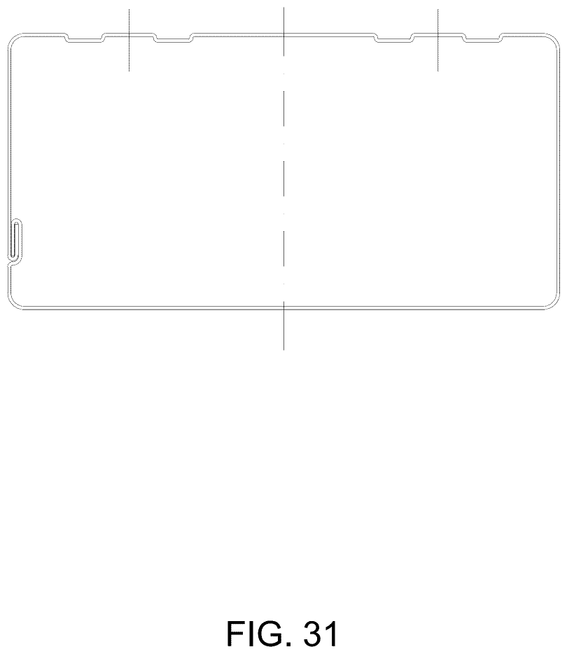

FIG. 32 is a structural schematic diagram 4 of a profile end plane according to the present invention; and

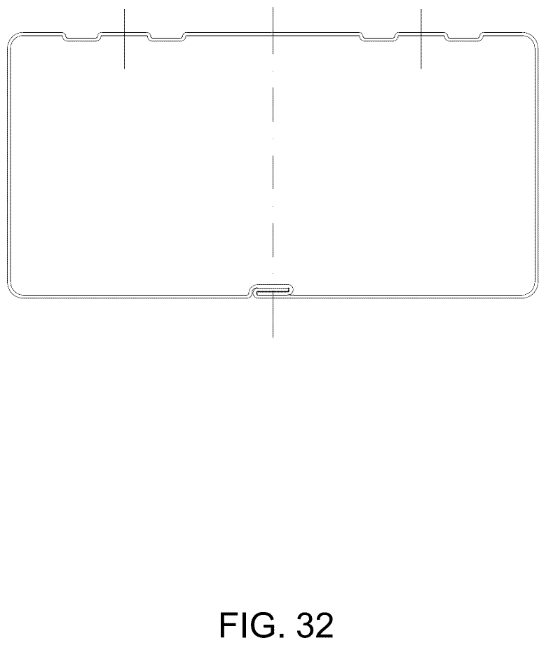

FIG. 33 is a structural schematic diagram 5 of a profile end plane according to the present invention.

### DESCRIPTION OF THE EMBODIMENTS

In order to make the technical means, creative features, achieved objectives and effects implemented by the present invention easy to understand, the present invention will be further elaborated with reference to the specific illustration.

### Embodiment 1

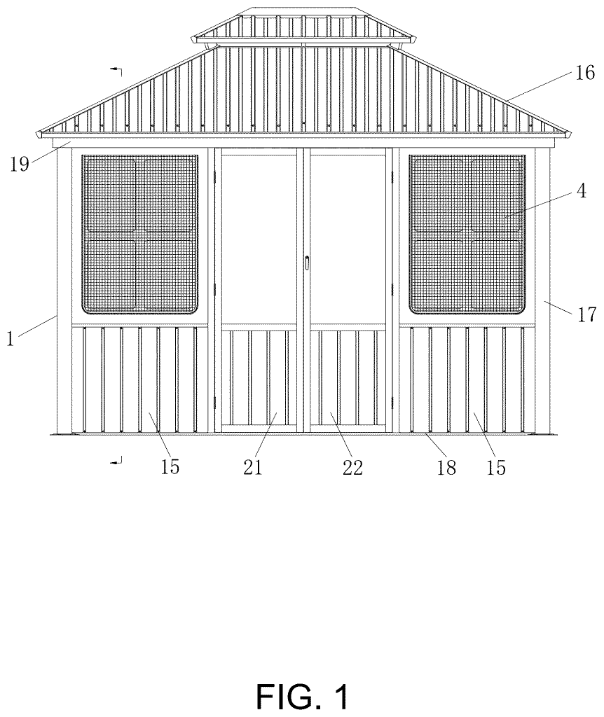

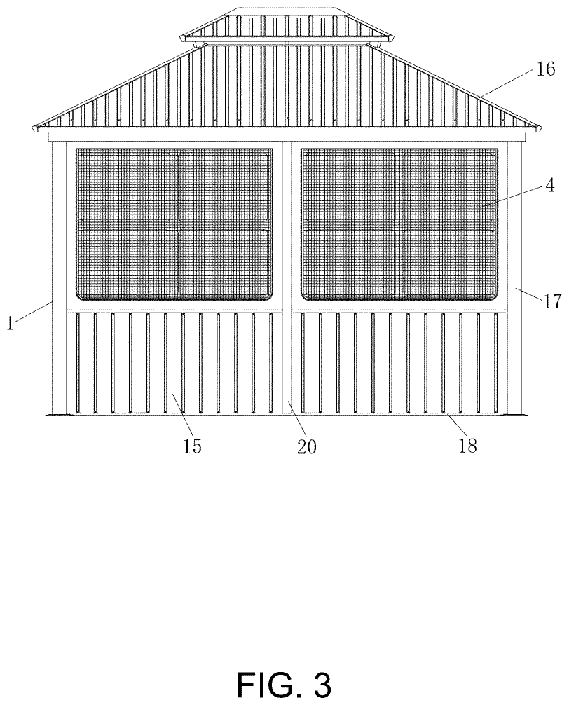

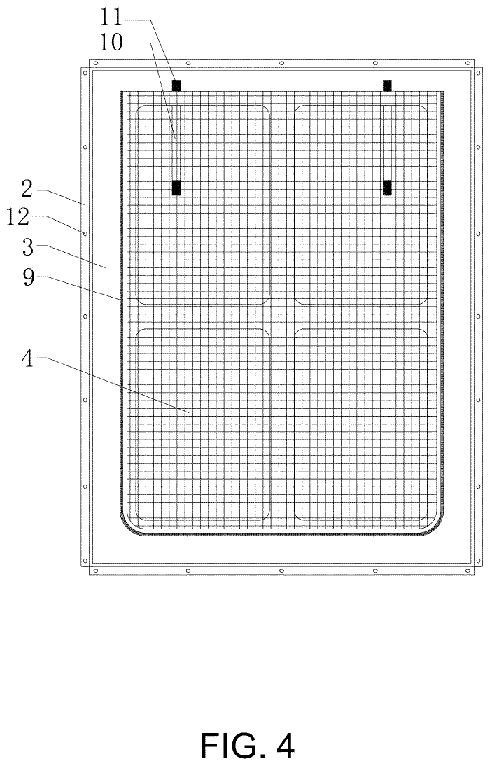

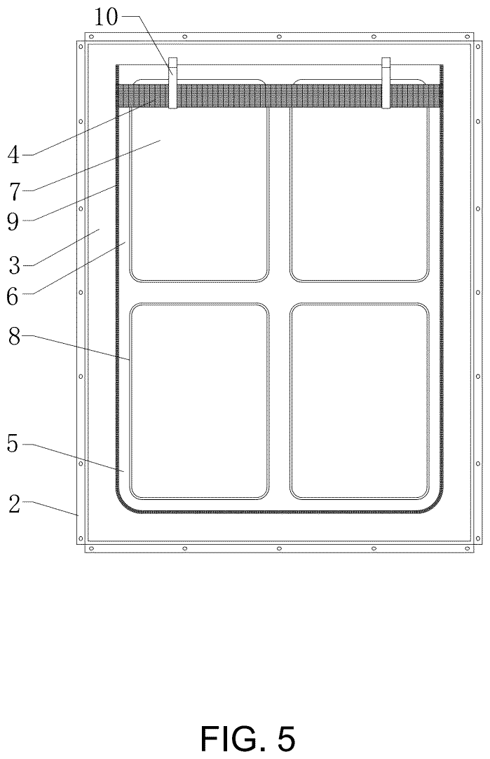

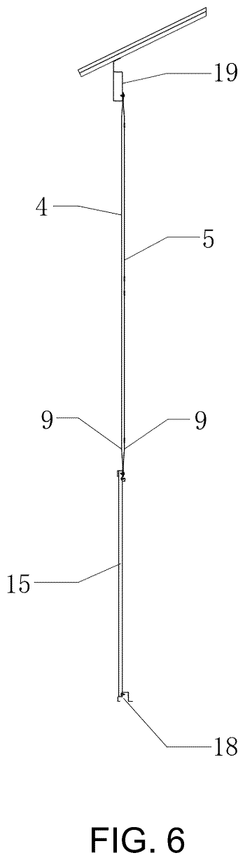

As shown in FIG. 1 to FIG. 9, the embodiment discloses an outdoor tent, in particular to an outdoor tent having multi-functional window bodies, the outdoor tent including a tent body 1 and window body components, and the window body components are disposed at one side of the tent body 1. As shown in FIG. 4 to FIG. 5, each of the window body components includes a frame 2, a window frame 3, and a flexible window body, the frame 2 is fixed on the tent body 1, an outer edge of the window frame is fixedly embedded on an inner side of the frame 2, and the flexible window body having at least two layers is disposed in the window frame 3; an upper part of the flexible window body is fixedly connected to the window frame 3, and other edges of the flexible window body are connected to the window frame 3 in an openable and closable manner.

The frame 2, which is made of cloth, is lined with a metal strip or a hard plastic strip, and the frame 2 is provided with a plurality of mounting holes 12 and is fixed on the tent body 1 through the mounting holes 12 and screws. The window frame 3, which is made of cloth, is connected to the frame 2 in a suture manner.

Each of the flexible window body and the window frame 3 has inner and outer layers, and the flexible window body includes an inner light-transmitting window body 5 and an outer screen window 4; upper edges of the screen window 4 and the light-transmitting window body 5 are fixedly connected to the window frame 3, other edges of the screen window 4 are connected to the outer window frame in an openable and closable manner, and other edges of the light-transmitting window body 5 are connected to an inner window frame in an openable and closable manner.

Upper edges of the screen window 4 and the light transparent window body 5 are fixedly connected to the window frame 3, and left, right, and lower edges of the screen window 4 and the light-transmitting window body 5 are connected to an inner edge of the window frame 3 through a zipper 9 or in a magnetic attraction manner. An inner ring of the window frame 3 is sewn with a zipper or a magnetic stripe, and outer rings of the screen window 4 and the light-transmitting window body 5 are correspondingly sewn with zippers or magnetic stripes for opening or closing the flexible window body.

The light-transmitting window body 5 includes a connecting frame 6 and light-transmitting modules 7, the light-transmitting modules 7 are fixed on the connecting frame 6, and an outer edge of the connecting frame 6 is connected to the window frame 3. Four light-transmitting modules 7 are distributed on the connecting frame 6. The connecting frame 6 is made of cloth, and an outer ring of the connecting frame 6 is sewn with a zipper or a magnetic stripe for being connected to the window frame 3 in an openable and closable manner.

The light-transmitting modules 7 are light-transmitting flexible films, and the light-transmitting flexible films are fixed on the connecting frame 6 through sutures. The light-transmitting window bodies with the light-transmitting flexible films are rolled up, and then fixed above the window frame with the ties 10.

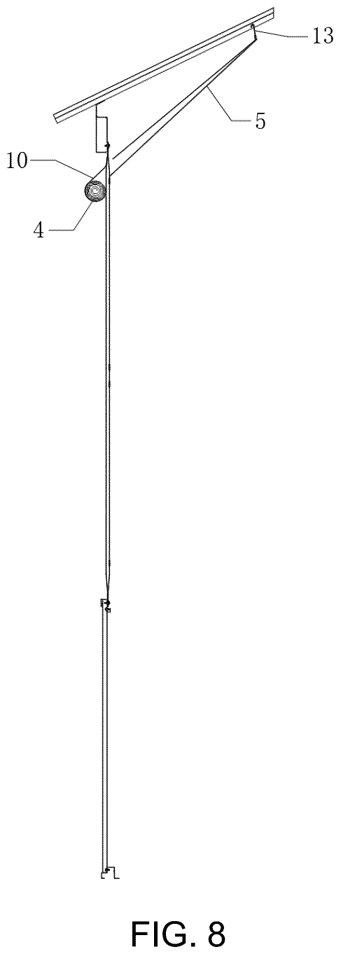

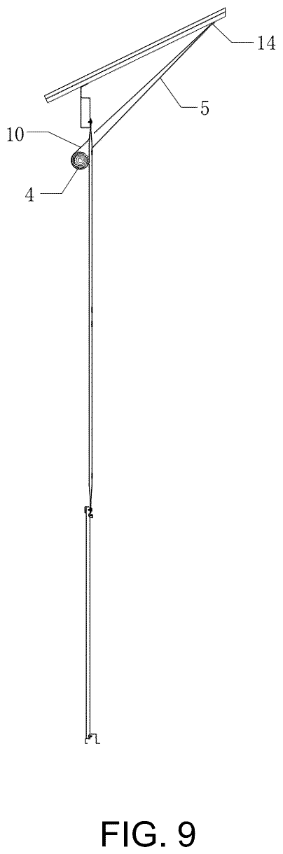

As shown in FIG. 8 and FIG. 9, the light-transmitting modules 7 are light-transmitting panels that are fixed on the connecting frame 6 through sutures 8, and hooks 13 or magnets 14 are provided inside lower parts of the light-transmitting panels, and the light-transmitting panels are connected to a ceiling 16 of the tent body 1 through hooks or in a magnetic attraction manner.

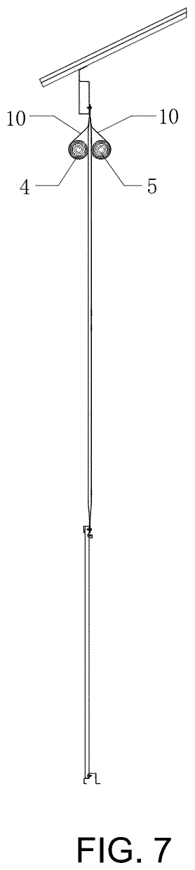

Ties 10 are disposed on the tent body 1, the ties 10 are located above the flexible window body, magic tapes 11 are disposed at upper and lower ends of the ties 10, and magic tapes 11 are correspondingly disposed on the tent body 1; as shown in FIG. 7, after the flexible window body is rolled up, the magic tapes 11 of the ties 10 are connected to the magic tapes on the tent body 1 in an attaching manner to fix the flexible window body rolled up above the window frame.

When ventilation is needed, the screen window 4 is rolled down, and the edge of the screen window 4 is connected to the window frame 3 through a zipper 9 or a magnetic stripe. If the light-transmitting modules of the light-transmitting window body 5 are the light-transmitting flexible films, the light-transmitting window body 5 can be rolled up and then fixed with the ties 10. As shown in FIG. 8 and FIG. 9, if the light-transmitting modules of the light-transmitting window body 5 is a light-transmitting panel, the lower part of the light-transmitting window body and the ceiling 16 of the tent body 1 are fixed by the hooks or in a magnetic attraction manner after the light-transmitting window body 5 is turned up.

When sealed ventilation is needed, the transparent window body 5 is rolled down, and the edge of the transparent window body 5 is connected to the window frame through the zipper 9 or the magnetic stripe. The screen window 4 is fixed by the ties 10 after being rolled up, and the screen window 4 and the light-transmitting window body 5 may be rolled down for use.

### Embodiment 2

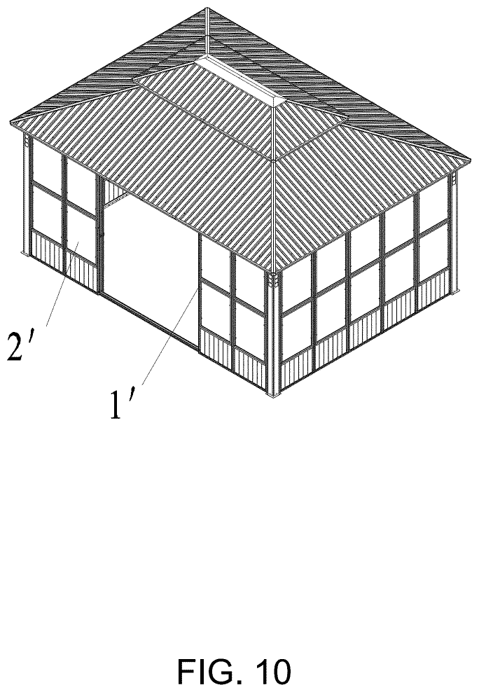

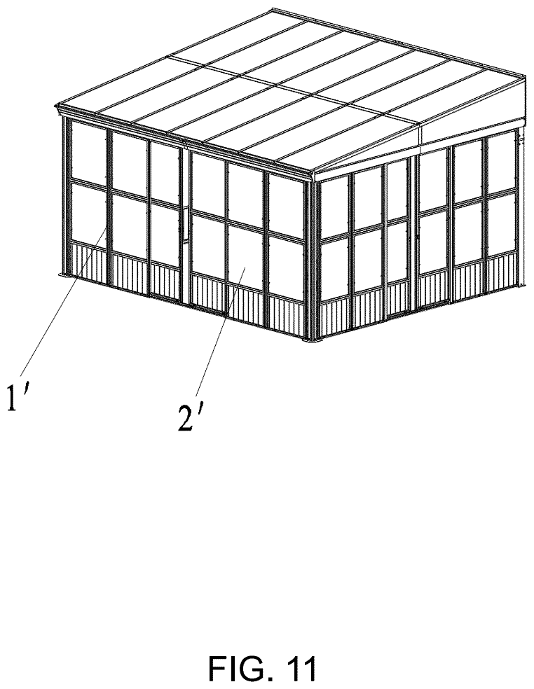

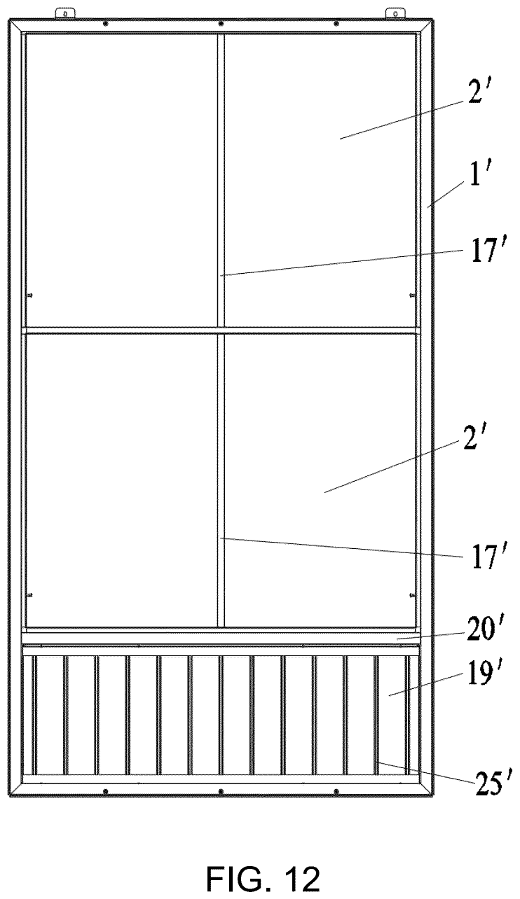

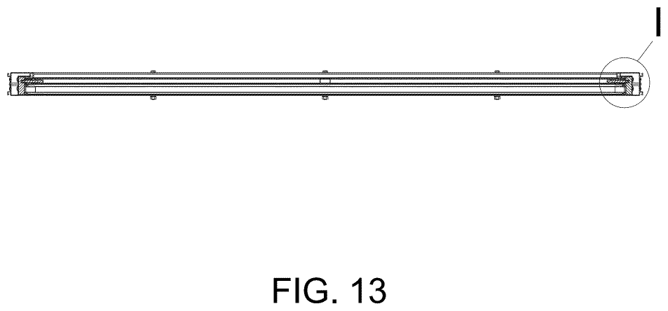

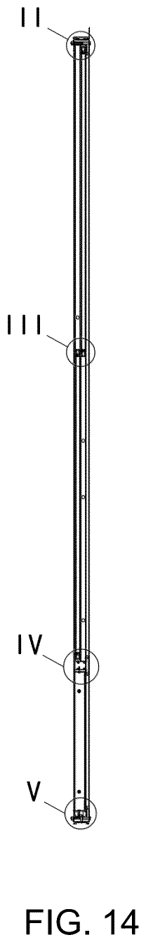

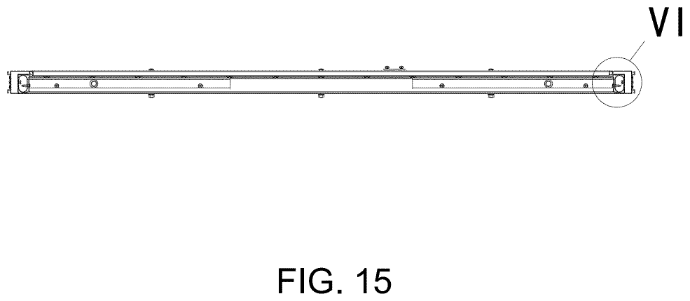

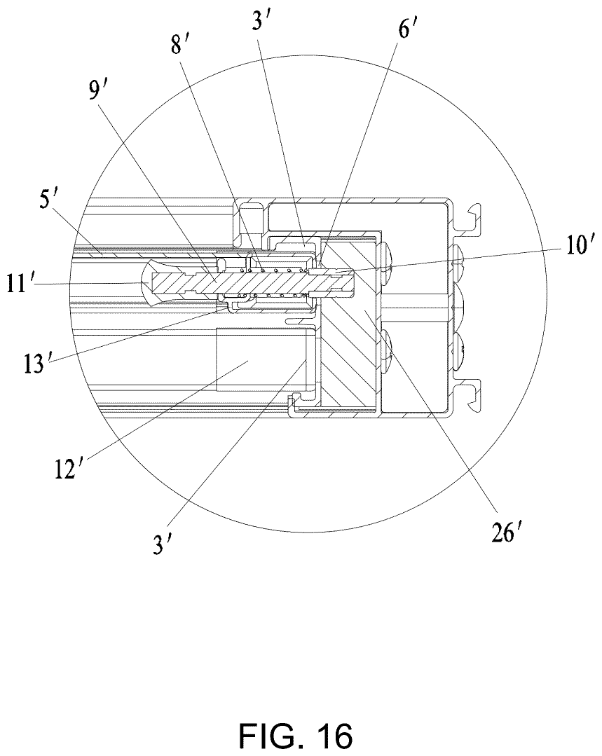

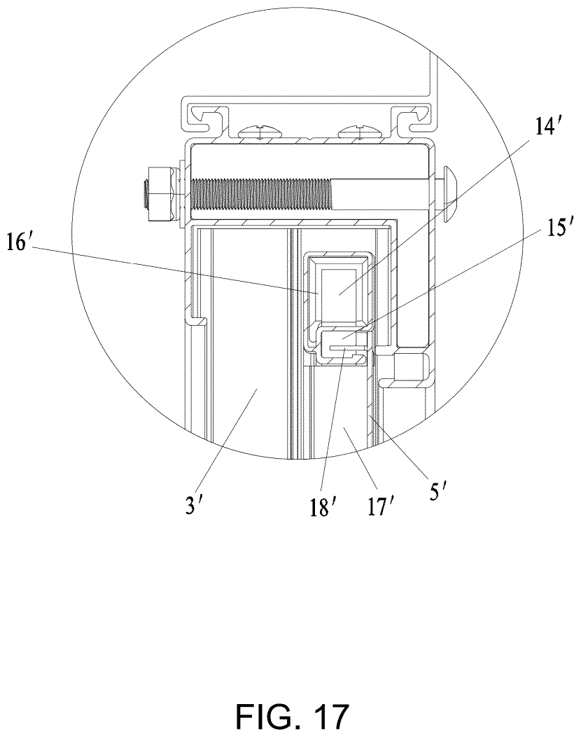

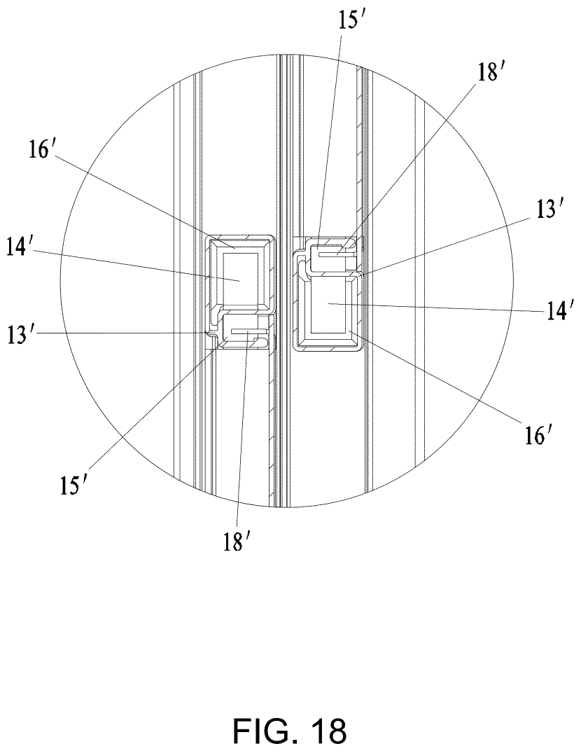

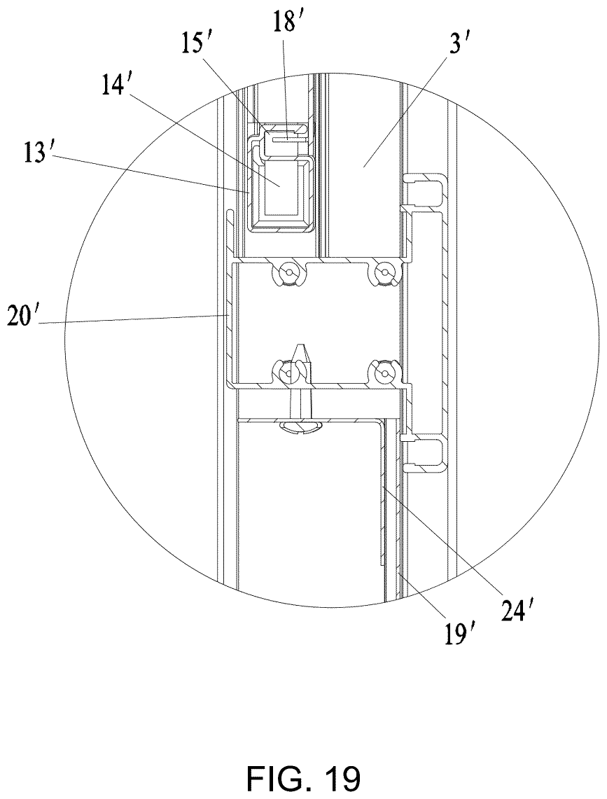

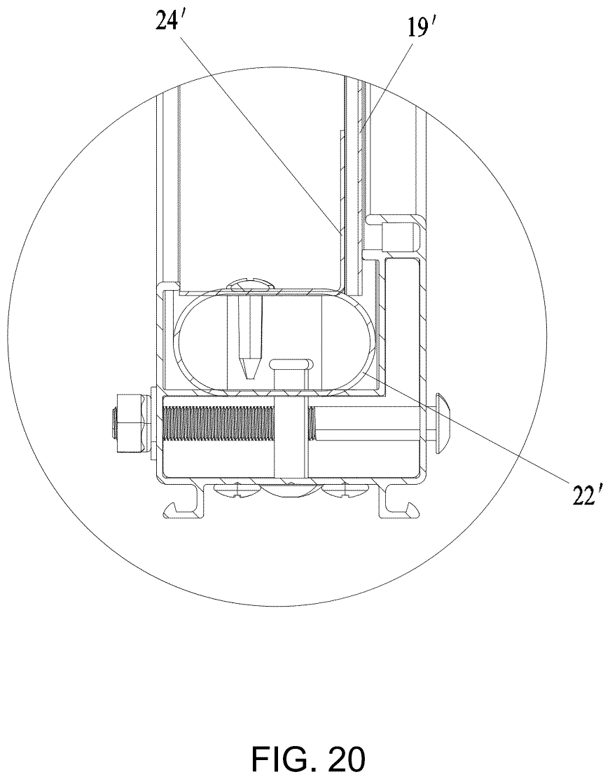

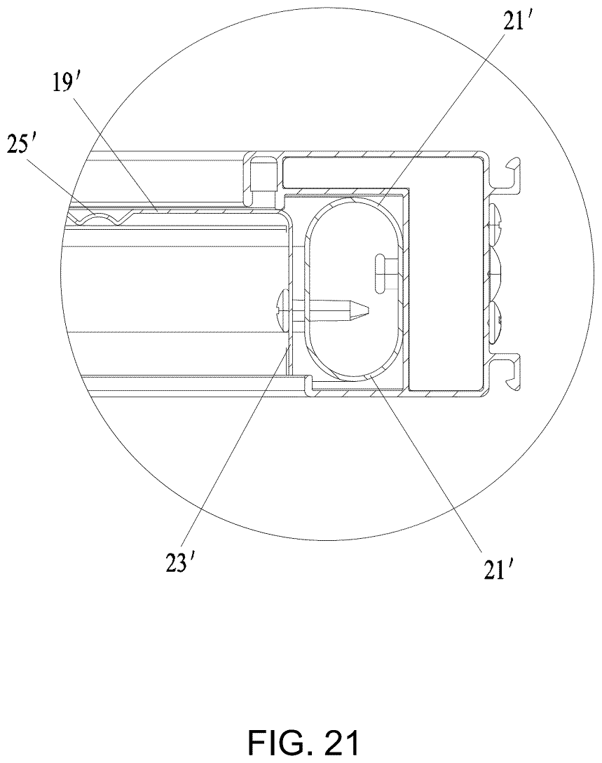

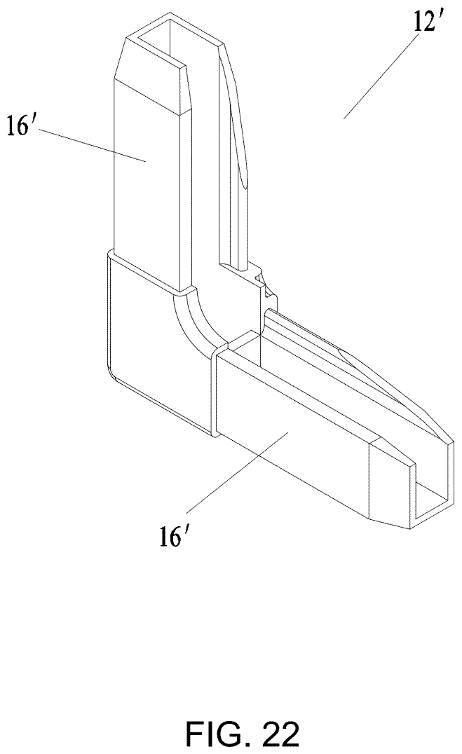

Based on Embodiment 1 and as shown in FIG. 10 to FIG. 22, the present disclosure discloses an outdoor tent, in particular to a side door and window structure for the outdoor tent, a sliding door or a door frame panel is further disposed on the tent body 1, and the sliding door or/and the door frame panel includes a frame body 1′ and a plurality of window body components 2′ disposed in the frame body 1′; the sliding door is a left door or a right door in Embodiment 1, and the door frame panel may be a fixed door panel; the frame body 1′ is internally provided with at least two parallel sliding chutes 3′, and the sliding chutes 3′ are configured to fit in with the window body components 2′; each of the window body components 2′ includes a window frame and a window body 5′ fixed on the window frame, the sliding chutes 3′ are internally provided with insertion holes 6′, and the window frame is correspondingly provided with movable bolts; when the movable bolts are locked with the insertion holes 6′, the window body components 2′ are fixed on the frame body 1′; and when the movable bolts are separated from the insertion holes 6′, the window body components 2′ are capable of sliding in the corresponding sliding chutes 3′. The insertion holes 6′ are formed at various places of the sliding chutes 3′ to locate and fix the window body components 2′, thus meeting people's ventilation and sunshade requirements at different heights. Elastic straps 26′ are provided between the sliding chutes 3′ and the frame body 1′, and the elastic straps 26′ deformed are embedded after the movable bolts are adaptively connected to the insertion holes 6′. The elastic straps 26′ are provided to reduce noise and wear when the movable bolts are inserted and removed.

Each of the movable bolts includes a pressure spring 8′ and a bolt body 9′, a pressure spring seat 10′ is disposed at a head part of the bolt body 9′, and an operating handle 11′ is disposed at a tail part of the bolt body 9′; and the pressure spring 8′ is sleeved on the bolt body 9′, and both ends of the pressure spring are respectively pressed into the pressure spring seat 10′ and the window frame. In a natural state, one end of the pressure spring 8′ acts on the window frame, and the other end thereof acts on the pressure spring seat 10′, thus keeping the movable bolts in the insertion holes 6. At this time, each of the window body component 2′ is fixed on the frame body l′. By pulling the operating handle 11′ to further compress the pressure spring 8′, the movable bolts can be removed from the insertion holes 6′, allowing the window body components 2′ to slide freely in the sliding chutes 3′.

The window frame includes four corner connectors 12′ and four frames 13′, each of the frames 13′ is formed by cutting a profile and includes a rectangular chamber 14′ and a zigzag-shaped chamber 15′, each of the corner connectors 12′ is provided with connecting posts 16′ that are perpendicular to each other, and the connecting posts 16′ are adaptively inserted into the rectangular chamber 14′. The window body 5′ is provided with a stiffener 17′, both ends of the stiffener 17′ are provided with first folding edges 18′, and the first folding edges 18′ are located in the zigzag-shaped chamber 15′ to prevent the reinforcing stiffener 17′ from falling off. After the profile is cut, the window frame may be assembled quickly by the four corner connectors 12′.

A reinforcing plate 19′ is further disposed in the frame body 1′, and a crossbar 20′ is disposed between the reinforcing plate 19′ and the window frame. The reinforcing plate 19′ is provided with a plurality of reinforcing ribs 25′. A first fixed support 21′ is disposed inside each of left and right sides of the frame body 1′, and second folding edges 23′ are disposed on each of left and right sides of the reinforcing plate 19′, and the second folding edges 23′ are mounted on the first fixed supports 21′ through fasteners. A lower end of the frame body 1′ is provided with a second fixed support 22′, and anti-falling plates 24′ are disposed on the crossbar 20′ and the second fixed support 22′ to prevent the reinforcing plate 19′ from falling off.

Operating principle of the side door and window structure for the outdoor tent: In a natural state, one end of the pressure spring 8′ acts on the window frame, and the other end thereof acts on the pressure spring seat 10′, thus keeping the movable bolts in the insertion holes 6. At this time, the window body components 2′ are fixed on the frame body 1′. By pulling the operating handle 11′ to further compress the pressure spring 8′, the movable bolts can be removed from the insertion holes 6′, allowing the window body components 2′ to slide freely in the sliding chutes.

As mentioned above, the present invention provides the side door and window structure for the outdoor tent, a structure where the movable bolts fit into the insertion holes is provided. After the movable bolts are removed from the insertion holes, the window body components can slide in the sliding chutes. The insertion holes are formed at different places of the sliding chutes to locate and fix the window body components, thus meeting people's ventilation and sunshade requirements at different heights.

### Embodiment 3

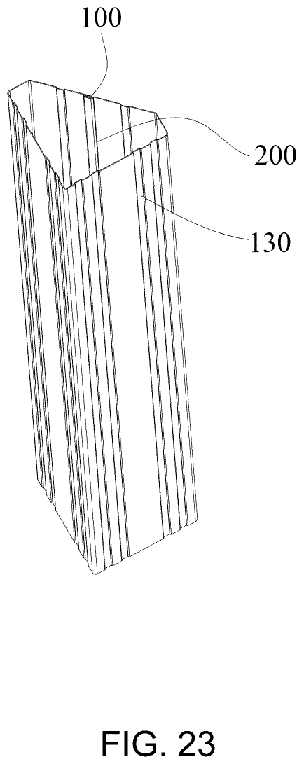

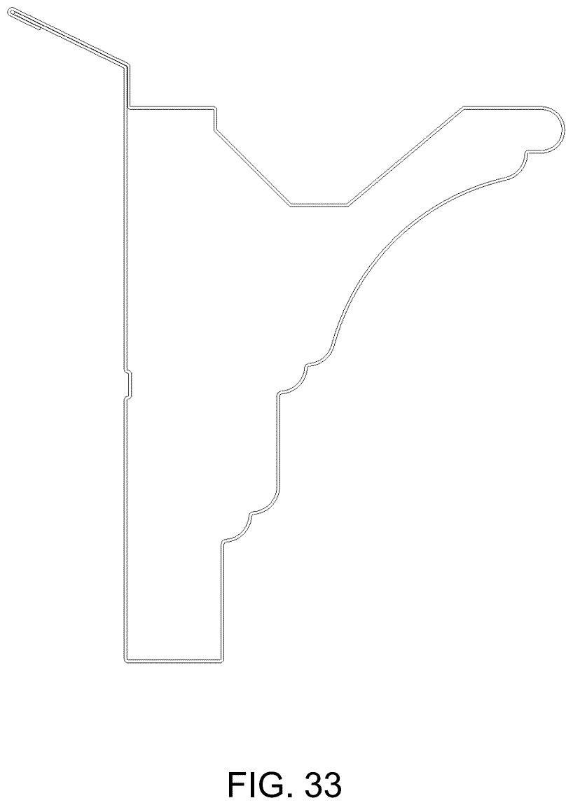

Based on Embodiment 1 and as shown in FIG. 23 and FIG. 33, the embodiment discloses an outdoor tent, in particular to a beam-post profile fixing structure for an outdoor tent, the beam-post profile fixing structure including a beam-post profile body 100, a cross section of the beam-post profile body 100 is polygonal cross-section, and the beam-post profile body 100 is internally provided with an internal cavity part 200; the beam-post profile body 100 is molded in a surrounding manner by adopting an iron sheet panel, one side of the iron sheet panel is a butt-joint edge 110, and the other side of the iron sheet panel is the fixed edge 120; the butt-joint edge 110 and the fixed edge 120 are fixed in a mutual closing and attachment manner; and the beam-post profile body 100 is either a tent leg tube or a tent ring beam for supporting the use of the outdoor tent.

Typically, the beam-post profile body 100 is molded in a surrounding manner by adopting an iron sheet panel, and the butt edge 110 and the fixed edge 120 are fixed in an overlapping and closing manner. In one of the preferred embodiments, the butt-joint edge 110 includes a first embedded edge 111, a first bending part 112, and a first extension part 113; the fixed edge 120 includes a second embedded edge 121, a second bending part 122, a second extension part 123, and a connection part 124, the first extension part 113 is a part of the beam-post profile body, and the first embedded edge 111, the second embedded edge 121, the first extension part 113, the second extension part 123 are overlapped with one another, and an overlapped place is fixed by stamping.

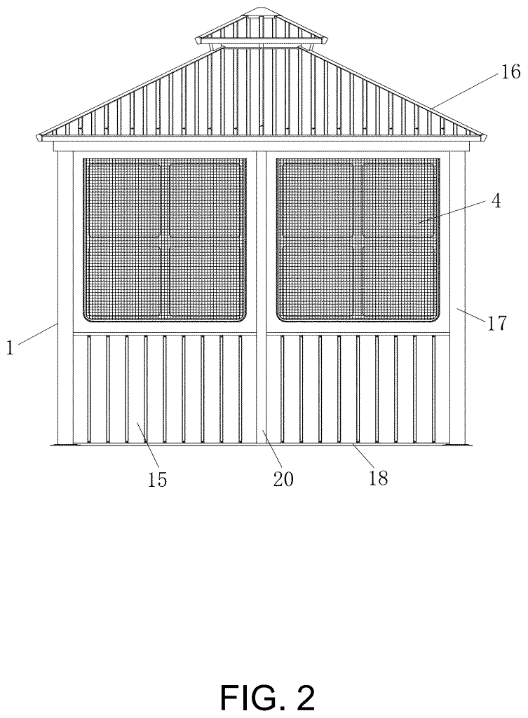

In one of the preferred embodiments, as shown in FIG. 2, after the beam-post profile body 100 is molded in a surrounding manner, a bending die is typically molded to enable the profile of the corresponding shape for the beam-post profile body 100 to form a stamped fastening edge 101, a first side plate 102, a first outer side plate 103, a second outer side plate 104, and a second side plate 105, reinforcing grooves 130 are formed in the second outer side plate 104 and the second side plate 105, and the butt-joint edge 110 and the fixed edge 120 are overlapped and stamped on the stamped fastening edge 101.

In one of the preferred embodiments, a cross section of the beam-post profile body 100 is triangular after being molded in a surrounding manner.

In one of the preferred embodiments, as shown in the figures, a cross section of the beam-post profile body 100 is rectangular after being molded in a surrounding manner, and a reinforcing groove 130 is formed in at least one side to improve the strength of the profile.

In one of the preferred embodiments, as shown in the figures, the beam-post profile body 100 includes a profile body 140 and an extension part 150, the butt-joint edge 110 and the fixed edge 120 are located on the extension part 150; the butt-joint edge 110 includes a covered edge 114, a third bending part 115, and a third extension part 116; and the fixed edge 120 includes a third embedded edge 126 and a fourth extension part 125, and the third embedded edge 126 is located between the covered edge 114 and the third extension part 116 and fixed by stamping.

The tent body according to the present invention can be molded in a surrounding manner by adopting the iron sheet panel to form the profiles of different specifications, offering good applicability and relatively low manufacturing cost. The covered edges on both sides are fixed by stamping to facilitate the molding and fixing of the beam-post profile, enhancing the stability of the profile formation.

Compared with the prior art, the present invention has the following beneficial effects:

1. A window according to the present invention has two layers of window body, including an outer screen window and an inner light-transmitting flexible film, both of which can be used for light transmittance and ventilation. When it rains, the light-transmitting window body can be easily rolled down to close the window, and sealed through a zipper or in a magnetic attraction manner. The flexible window body can be connected in an openable and closable manner to facilitate fixing and connection. The window is sewn by a flexible material, offering dual functionality as both the screen window and the light-transmitting sealed window body; and the window can be opened and closed flexibly through the zipper or in a magnetic attraction manner depending on different occasions.

2. According to the present invention, a structure where the movable bolts fit into the insertion holes is provided. After the movable bolts are removed from the insertion holes, the window body components can slide in the sliding chutes. The sliding chutes are internally provided with the insertion holes at various positions to locate and fix the window body components, thus meeting people's ventilation and sunshade requirements at different heights.

3. The tent body according to the present invention can be molded in a surrounding manner by adopting the iron sheet panel to form the profiles of different specifications, offering good applicability and relatively low manufacturing cost. The covered edges on both sides are fixed by stamping to facilitate the molding and fixing of the beam-post profile, enhancing the stability of the profile formation.

The features of the present invention can be clearly understood with reference to the illustrations herein and the detailed description of the preferred embodiments provided below.

What is said above is the preferred embodiments of the present invention, but is not intended to limit the present invention in any form. Any simple changes, substitutions and alterations made based on the technical principle of the present invention still fall with the scope of the technical solution of the present invention.

What is claimed is:

1. An outdoor tent, comprising a tent body and window body components, wherein the window body components are disposed on the tent body; each of the window body components comprises a frame, a window frame, and a flexible window body; the frame is fixed on the tent body, an outer edge of the window frame is fixedly embedded on an inner side of the frame, and the flexible window body having at least two layers is disposed in the window frame; an upper part of the flexible window body is fixedly connected to the window frame, and other edges of the flexible window body are connected to the window frame in an openable and closable manner; the flexible window body comprises an inner light-transmitting window body and an outer screen window; and upper edges of the screen window and the light-transmitting window body are fixedly connected to the window frame, other edges of the screen window are connected to an outer window frame in an openable and closable manner, and other edges of the light-transmitting window body are connected to an inner window frame in an openable and closable manner.

2. The outdoor tent according to claim 1, wherein left, right, and lower edges of the screen window and the light-transmitting window body are connected to an inner edge of the window frame through a zipper or in a magnetic attraction manner.

3. The outdoor tent according to claim 1, wherein the light-transmitting window body comprises a connecting frame and light-transmitting modules, the light-transmitting modules are fixed on the connecting frame, and an outer edge of the connecting frame is connected to the window frame.

4. The outdoor tent according to claim 3, wherein the light-transmitting modules are light-transmitting flexible films that are fixed on the connecting frame through sutures.

5. The outdoor tent according to claim 3, wherein the light-transmitting modules are light-transmitting panels that are fixed on the connecting frame through sutures, hooks or magnets are disposed inside lower parts of the light-transmitting panels, and the light-transmitting panels are connected to a ceiling of the tent body through the hooks or in a magnetic attraction manner.

6. The outdoor tent according to claim 1, wherein ties are disposed on the tent body, the ties are located above the flexible window body, magic tapes are disposed at upper and lower ends of the ties, magic tapes are disposed on the tent body, and the magic tapes of the ties are connected to the magic tapes on the tent body in an attaching manner after the flexible window body is rolled up.

7. The outdoor tent according to claim 1, wherein mounting holes are formed in the frame, and the frame is fixed on the tent body through the mounting holes and screws.

8. The outdoor tent according to claim 1, wherein a sliding door or a door frame panel is further disposed on the tent body, and the sliding door or/and the door frame panel comprises a frame body and a plurality of window body components disposed in the frame body; the frame body is internally provided with at least two parallel sliding chutes, and the sliding chutes are configured to fit in with the window body components; each of the window body components of the sliding door or/and the door frame panel comprises a window frame and a window body fixed on the window frame, the sliding chutes are internally provided with insertion holes, and the window frame is correspondingly provided with movable bolts; when the movable bolts are locked with the insertion holes, the window body components of the sliding door or/and the door frame panel are fixed on the frame body; and when the movable bolts are separated from the insertion holes, the window body components of the sliding door or/and the door frame panel are capable of sliding in the corresponding sliding chutes.

9. The outdoor tent according to claim 8, wherein elastic straps are provided between the sliding chutes and the frame body, and the elastic straps deformed are embedded after the movable bolts are adaptively connected to the insertion holes.

10. The outdoor tent according to claim 8, wherein each of the movable bolts comprises a pressure spring and a bolt body, a pressure spring seat is disposed at a head part of the bolt body, and an operating handle is disposed at a tail part of the bolt body; and the pressure spring is sleeved on the bolt body, and both ends of the pressure spring are respectively pressed into the pressure spring seat and the window frame.

11. The outdoor tent according to claim 8, wherein the window frame comprises four corner connectors and four frames, each of the frames is formed by cutting a profile and comprises a rectangular chamber and a zigzag-shaped chamber, each of the corner connectors is provided with connecting posts that are perpendicular to each other, and the connecting posts are adaptively inserted into the rectangular chambers.

12. The outdoor tent according to claim 11, wherein the window body is provided with a stiffener, both ends of the stiffener are provided with first folding edges, and the first folding edges are located in the zigzag-shaped chambers.

13. The outdoor tent according to claim 8, wherein a reinforcing plate is further disposed in the frame body, and a crossbar is disposed between the reinforcing plate and the window frame.

14. The outdoor tent according to claim 13, wherein a first fixed support is disposed inside each of left and right sides of the frame body, and second folding edges are disposed on each of left and right sides of the reinforcing plate, and the second folding edges are respectively mounted on the first fixed support through fasteners; a second fixed support is mounted at a lower end of the frame body, and anti-falling plates are mounted on the crossbar and the second fixed support; and the reinforcing plate is provided with a plurality of reinforcing ribs.

15. The outdoor tent according to claim 1, wherein the tent body comprises post corners, ring beams, or middle partition posts, any one of the post corners, the ring beams, or the middle partition posts is formed by adopting a beam-post profile body, the beam-post profile body is internally provided with a cavity part, and the beam-post profile body is molded in a surrounding manner by adopting an iron sheet panel; and one side of the iron sheet panel is a butt-joint edge, and the other side of the iron sheet panel is a fixed edge, and the butt-joint edge and the fixed edge are fixed in a mutual closing and attachment manner.

16. The outdoor tent according to claim 15, wherein the butt-joint edge comprises a first embedded edge, a first bending part, and a first extension part; the fixed edge comprises a second embedded edge, a second bending part, a second extension part, and a connection part, the first extension part is a part of the beam-post profile body, and the first embedded edge, the second embedded edge, the first extension part, and the second extension part are overlapped with one another.

17. The outdoor tent according to claim 16, wherein after the beam-post profile body is molded in a surrounding manner, a stamped fastening edge, a first side plate, a first outer side plate, a second outer side plate, and a second side plate are formed, reinforcing grooves are formed in the first outer side plate and the second outer side plate, and the butt-joint edge and the fixed edge are fixed in an overlapping and closing manner.

18. The outdoor tent according to claim 16, wherein a cross section of the beam-post profile body is rectangular after being molded in a surrounding manner, and a reinforcing groove is formed in at least one side.

19. The outdoor tent according to claim 16, wherein the beam-post profile body comprises a profile body and an extension part, and the butt-joint edge and the fixed edge are located on the extension part; the butt-joint edge comprises a covered edge, a third bending part, and a third extension part; and the fixed edge comprises a third embedded edge and a fourth extension part, and the third embedded edge is located between the covered edge and the third extension part.

20. The outdoor tent according to claim 15, wherein a thickness of the beam-post profile body is 0.4 mm to 1.0 mm.
